(19) United States
(12) Patent Application Publication
(10) Pub. No.: US 2015/0079258 A1
(43) Pub. Date: Mar. 19, 2015

(54) COMBINATION DOUBLE PEELER AND HOLDER DEVICE

(71) Applicant: Ideavillage Products Corp., Wayne, NJ (US)

(72) Inventor: Aaron Szymanski, Watertown, CT (US)

(21) Appl. No.: 14/486,237

(22) Filed: Sep. 15, 2014

Related U.S. Application Data
(60) Provisional application No. 61/877,763, filed on Sep. 13, 2013.

(51) Int. Cl. A47J 17/02; A23P 1/00; B26B 11/00; B26D 3/28; B26D 7/01

(52) U.S. Cl. CPC A47J 17/02; B26D 3/283; B26D 7/01; B26B 11/00; A23P 1/00; B26D 2003/287
USPC 426/479; 30/124; 30/125; 83/13; 83/39

(57) ABSTRACT

A combination kitchen device includes a double peeler having a substantially hollow handle having a forward end and a rearward end and a releasably engageable holding tool inserted within the rearward end of the hollow handle. The double peeler includes a head connected transversely to the forward end of the hollow handle. The head has at least one recess, and at least one means for cutting mounted within the recess. The head has an opening having an eye removal cutting edge. The holding tool has a handle portion and an elongated blade portion attached transversely to the handle portion.

### CROSS-REFERENCE TO RELATED APPLICATION

This application claims priority to U.S. Provisional Patent Application Ser. No. 61/877,763, entitled “Combination Peeler and Holder”, filed in the United States Patent and Trademark Office on Sep. 13, 2013, the entire disclosure of which is incorporated by reference herein.

### BACKGROUND OF THE INVENTION

1. Field of the Invention

This invention relates generally to kitchen tools for removing a peel from a fruit or vegetable, and more particularly, to a combination double peeler and holder device for securing a food item while peeling or cutting.

2. Description of the Related Art

Traditional methods of peeling foods with soft and hard skins and peeling foods into thin strips require a user to utilize more than one tool. Specifically, one tool for peeling skins, one for removing unwanted spots, another tool for creating thin strips, and yet another tool for holding the food while peeling. Currently, there are no alternatives for kitchen tools which combine all of these functions in a compact and convenient device.

It is, therefore, a primary object of the present invention to combine multiple kitchen tools in one useful and versatile combination device for peeling and stripping a variety of foods having different skin types, all while simultaneously stabilizing the food.

It is another object of the present invention to provide a more versatile combination kitchen tool featuring a double peeler, including a straight edge blade for peeling fruits and vegetables and a julienne blade for cutting foods into thin strips.

It is another object of the present invention to provide the double peeler with an opening having an eye removal cutting edge for removing unwanted areas of the food item.

It is another object of the present invention to provide an integrated holder within the combination device which can pierce into foods before peeling to securely engage the food and distance a user's hands from the blade as the food is more quickly peeled.

It is another object of the present invention to provide an integrated holder capable of sliding and securing within the handle of the combination device for compact and convenient storage.

### BRIEF SUMMARY OF THE INVENTION

In accordance with one aspect of the present invention,

In accordance with an additional embodiment, a

### BRIEF DESCRIPTION OF THE SEVERAL VIEWS OF THE DRAWINGS

To these and to such other objects that may hereinafter appear, the present invention relates to a combination double peeler and holder device for securing a food item while peeling or cutting as described in detail in the following specification and recited in the annexed claims, taken together with the accompanying drawings, in which like numerals refer to like parts in which:

FIG. 1 is a perspective view of a combination device, showing a double peeler having a head and a hollow handle for receiving a holding tool therein in accordance with the present invention;

FIG. 2 is a front plan view of the combination double peeler and holder device, showing the opposed blade members of the peeler head in accordance with the present invention;

FIG. 3 is a rear plan view of the combination double peeler and holder device, showing the holding tool within the hollow handle in accordance with the present invention;

FIG. 4 is a side plan view of the combination double peeler and holder device, showing opposing blade members and an eye removal opening in accordance with the present invention;

FIG. 5 is a top plan view of the combination double peeler and holder device, showing the first blade member having straight edges for peeling fruits and vegetables in accordance with the present invention;

FIG. 6 is a bottom plan view of the combination double peeler and holder device, showing the second blade member having protrusions for cutting foods into thin strips in accordance with the present invention;

FIG. 7 is a side plan view of the holding tool of the combination double peeler and holder device, showing a handle portion and transversely connected elongated blade portion in accordance with the present invention; and

FIG. 8 is a perspective view of the combination peeler and holder device, showing the holding tool removed from the hollow handle of the double peeler in accordance with the present invention.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### DETAILED DESCRIPTION OF THE INVENTION

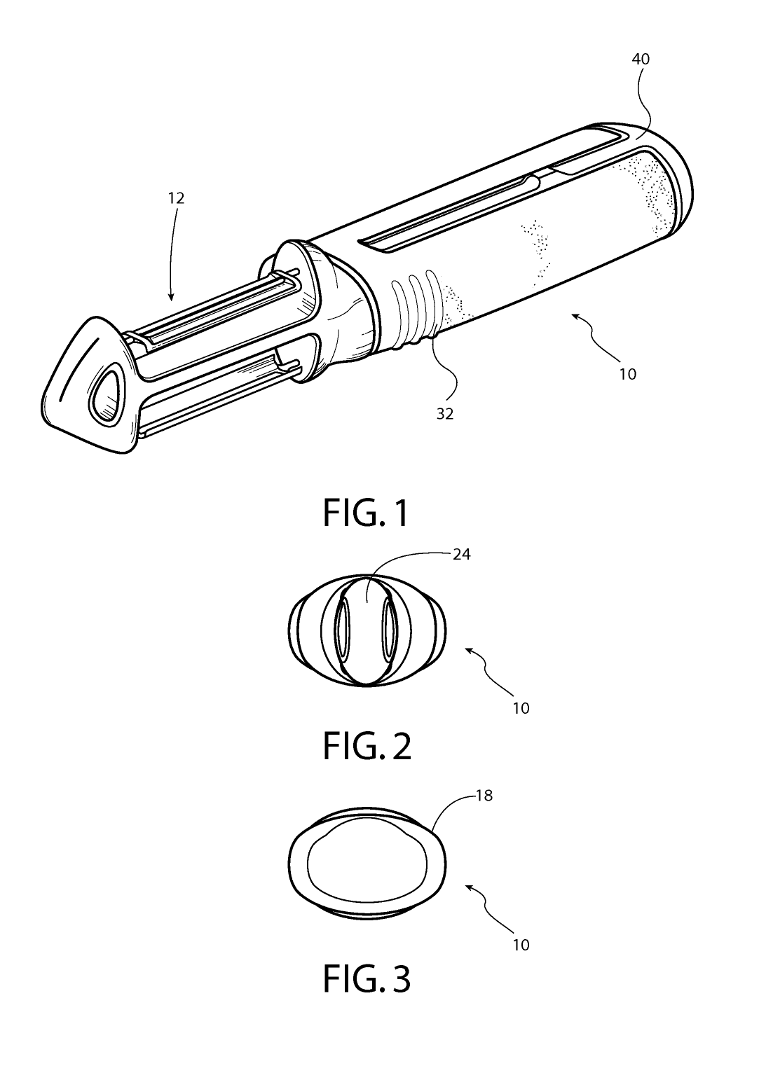

FIGS. 1-8 illustrate the present invention, which is directed to a combination double peeler and holder device 10. In its broadest context, shown in FIGS. 1-3 and 8, the combination device includes a double peeler 12 and an integrated holding tool 50 for simultaneously securing and peeling a food item.

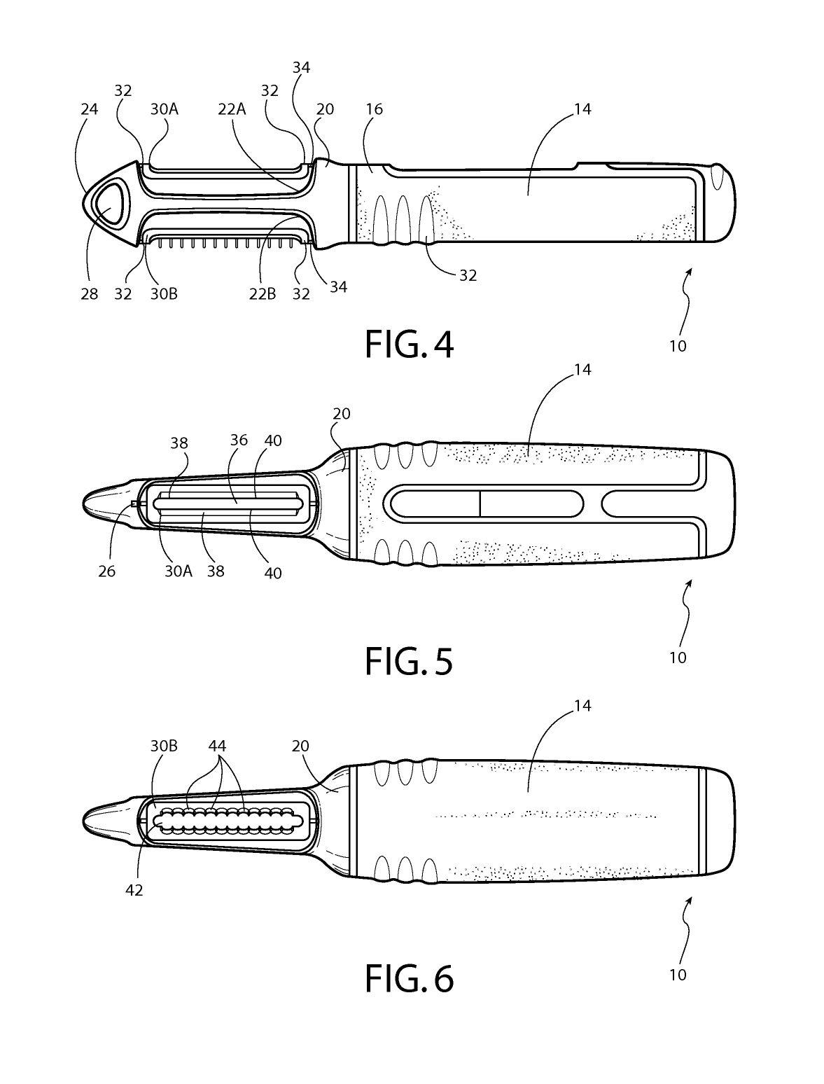

FIGS. 4-6 illustrate the double peeler 12, which includes a substantially hollow handle 14 having a forward end 16 and a rearward end 18. The forward end 16 of the handle 14 is transversely connected to a head 20 having at least two opposed recesses 22A, 22B. The recesses include blade retaining means 26, preferably opposed channels or holes. The head 20 includes a substantially tapered distal end 24 having an opening 28 including an eye removal means or cutting edge 27. The eye removal cutting edge 28 may be used to remove unwanted or spoiled areas of the food item, for example eyes on a potato. The opening may also act as a hook to hang the device 10 after use. The hollow handle includes an exterior surface 14A having at least one gripping means 32, preferably a rib.

FIG. 4 illustrates the double peeler 12, which includes a pair of longitudinally extending blade members 30, including a first blade member and a second blade member 30A, 30B. The blade members 30A, 30B have opposing longitudinal ends 32 each having means for connecting 34, preferably by a pin extending outwardly therefrom. The pins 34 of the blade members 30A, 30B are accepted and locked within the holes 26 of the recesses 22A, 22B of the head 20, as shown in FIG. 5. The pins 34 may be fixed or moveable within the holes 26.

FIG. 5 illustrates the first blade members 30A, having a centrally disposed elongated opening 36 extending longitudinally therethrough. The first blade member 30A includes a pair of sharp cutting edges 38 or regions, wherein each edge 38 forms an opposing longitudinally extending side 40 of the elongated opening 36. The cutting edges 38 of the first blade member 30A are ideal for peeling fruits and vegetables including hard skins of potatoes, cucumbers, carrots, beets, apples and pears, as well as softer skins of kiwis and tomatoes.

FIG. 6 illustrates the second blade member 30B, having a centrally disposed elongated strip 42 including a plurality of equally spaced protrusions 44 extending outwardly therefrom. The protrusions 44 of the second blade member 30B are ideal for julienning or thinly stripping fruits, vegetables and other food items. In particular, cheese, cucumber, and carrots.

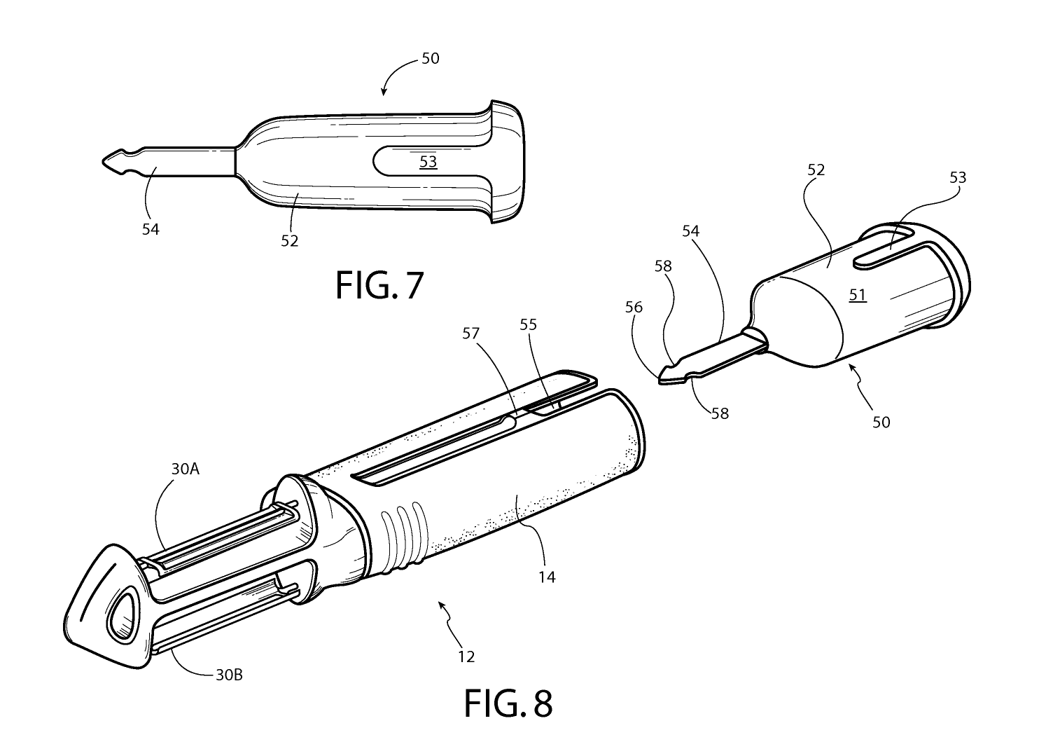

FIGS. 7 and 8 illustrates the integrated holding tool of the present invention, which is removably connected within the rearward end 18 of the hollow handle 14. The holding tool 50 includes a handle portion 52 and an elongated blade portion 54 attached transversely to the handle portion 52. The blade portion 54 includes a tapered distal end 56 for inserting into the food item. When the tapered distal end 56 is engaged within the food item, the handle portion 52 is held by the user thereby distancing the user's hands from the blade members 30 as the food is more quickly peeled. The blade portion 54 includes opposed indentations 58, preferably semi-circular in design, proximate the tapered distal end 56. The handle portion 52 includes an exterior surface 51 having means for securely connecting with the hollow handle 14, preferably the connecting means is an elongated raised protrusion 53. The hollow handle 14 includes means for securely accepting at least a portion of the holding tool 50 therein, preferably a receiving opening 55 and stopper 57.

In use, a user removes the holding tool 50 from the handle 14 of the double peeler 12. Next, the tapered distal end 56 of the holding tool 50 is inserted or pierced into a food item and the user holds the handle portion 52 to control and stabilize the food item. Using the other hand, the user grips the handle 14 of the double peeler 12 and peels, cuts, slices, or juliennes the food item using either the first or second blade member 30A, 30B. The user may selectively alternate between blade members 30A, 30B. The user may also remove unwanted spots using the eye removing cutting edge 27. Once the item is peeled, the user removes the holding tool 50 from the food item and inserts the tapered distal end 56 back into the handle 14 of the double peeler and hangs the device 10 by the opening 28 for convenient storage.

It will now be appreciated that the present invention relates to a combination double peeler and holding tool. The invention is illustrated by example in the drawing figures, and throughout the written description.

It should be understood that numerous variations are possible, while adhering to the inventive concept. Such variations are contemplated as being a part of the present invention.

While only a limited number of preferred embodiments of the present invention have been disclosed for purposes of illustration, it is obvious that many modifications and variations could be made thereto. It is intended to cover all of those modifications and variations, which fall within the scope of the present invention as defined by the following claims.

I claim:

1. A combination kitchen device, comprising:
a peeler having a substantially hollow handle having a forward end and a rearward end, a head connected transversely to said forward end of said hollow handle and said head having at least one recess, and at least one means for cutting mounted within said recess of said head; and
a holding tool releaseably engageable with said double peeler, said tool having a handle portion and an elongated blade portion attached transversely to said handle portion.

2. The combination kitchen tool of claim 1 wherein the cutting means includes a blade member having opposing longitudinal ends having means for connecting.

3. The combination kitchen tool of claim 2 wherein the connecting means includes a pair of pins, each pin extending from one of the longitudinal ends of the blade member.

4. The combination kitchen tool of claim 3 wherein the head includes a blade member retaining means operatively associated therewith for retaining the pins of the ends of the blade member within the recess of the head.

5. The combination kitchen tool of claim 2 wherein the blade member of the cutting means may be from the group consisting of straight edge blades, julienne blades, and serrated blades.

6. The combination kitchen tool of claim 1 wherein said holding tool is inserted into the rearward end of the hollow handle.

7. A combination food peeler and holder, comprising:
a substantially hollow handle having a forward end and a rearward end;
a head connected transversely to said forward end of said hollow handle, said head having a pair of opposed recesses;
a pair of longitudinally extended blade members each mounted within one of said opposed recess of said head, each said blade member having opposing longitudinal ends and a pin extending from each end, one of said blade members having a centrally disposed elongated opening extending longitudinally therethrough and having a sharp cutting region adjacent said opening, the other of said blade members having an elongated strip having a plurality of cutting protrusions equally spaced and extending outwardly therefrom;
a blade member retaining means operatively associated with said recesses of said head for retaining said pins of said ends of said blade members within said opposed recesses of said head; and
a holding tool having a handle portion and an elongated blade portion attached transversely to said handle portion,
wherein said holding tool and said hollow handle releasably engage, such that said holding tool is inserted into said rearward end of said hollow handle.

8. The combination food peeler and holder of claim 7 wherein the opposed recesses of the head include guide channels for accepting the pins of the blade members therein.

9. The combination food peeler and holder of claim 7 wherein the opposed recesses of the head include openings for accepting and locking the pins of the blade members therein.

10. The combination food peeler and holder of claim 7 wherein the pins are fixed with the recesses for prohibiting movement of the blade members.

11. The combination food peeler and holder of claim 7 wherein the pins pivot within the recesses for allowing swivel movement of the blade members.

12. The combination food peeler and holder of claim 7 wherein the head includes an opening having an eye removal cutting edge.

13. The combination food peeler and holder of claim 7 wherein the sharp cutting region of the blade member may be a straight edge blade, serrated edge blade, or julienne blade.

14. The combination food peeler and holder of claim 7 wherein the hollow handle includes an exterior surface having at least one gripping portion.

15. The combination food peeler and holder of claim 7 wherein the blade portion of the holding tool includes a tapered distal end.

16. The combination food peeler and holder of claim 7 wherein the elongated blade portion of the holding tool includes means for engaging the food item.

17. The combination food peeler and holder of claim wherein the engaging means are opposed indentations.

18. The combination food peeler and holder of claim 7 wherein the handle portion of the holding tool includes an exterior surface having means for securely connecting with said hollow handle portion.

19. The combination food peeler and holder of claim wherein the hollow handle includes means for securely accepting at least a portion of the holding tool.

20. A method of peeling a food item using a combination device having the peeler and holding tool of claim 7, the steps comprising:
a) removing the holding tool from the hollow handle of the peeler;
b) inserting the elongated blade portion of the holding tool into the food item;
c) holding the handle portion of the holding tool to stabilize and control the food item;
d) gripping the hollow handle of the peeler with the other hand;
e) peeling or cutting the food item using at least one of the blade members of the peeler;
f) removing the holding tool from the food item; and
g) storing the holding tool by inserting the elongated blade portion into the handle of the peeler.

21. The method of peeling a food item of claim 20, the steps further comprise rotating the double peeler and peeling or cutting the food item using the other blade member.

22. The method of peeling a food item of claim 20, the steps further comprise removing unwanted portions of the food item using an eye removal cutting edge.
